(19) United States
(12) Patent Application Publication
(10) Pub. No.: US 2026/0064052 A1
(43) Pub. Date: Mar. 5, 2026

(54) IMAGE FORMING APPARATUS FOR FORMING IMAGE ON PRESSURE-BONDING PRINT

(71) Applicant: CANON KABUSHIKI KAISHA, Tokyo (JP)

(72) Inventors: KOTA MORI, Chiba (JP); SHINGO HIROTA, Ibaraki (JP); KENICHIRO KITAJIMA, Ibaraki (JP); NAOYUKI YAMAMOTO, Chiba (JP); TOHRU NAKAEGAWA, Chiba (JP); SHUICHI TAMURA, Ibaraki (JP)

(21) Appl. No.: 19/313,214

(22) Filed: Aug. 28, 2025

(30) Foreign Application Priority Data
Sep. 4, 2024 (JP) 2024-151935

(51) Int. Cl. G03G 15/20; G03G 15/00; G03G 15/16

(52) U.S. Cl. CPC G03G 15/205; G03G 15/1605; G03G 15/1675; G03G 15/2064; G03G 15/5016; G03G 15/80; G03G 2215/00413; G03G 2215/00472; G03G 2215/00523; G03G 2215/00742; G03G 2215/00772; G03G 2215/00776; G03G 2215/2025; G03G 2215/2045

(57) ABSTRACT

An image forming apparatus includes an image forming portion configured to form a toner image on a recording material; a fixing portion configured to fix the toner image, on the recording material, formed on the recording material by the image forming portion; an input portion configured to input information on the recording material; and a controller. In a case where the controller executes an operation in a first mode in which the toner image is formed on a pressure-bonded recording material bent and pressure-bonded so that one surface of the recording material becomes an opposing inner surface, the controller controls the fixing portion on the basis of first information on a basis weight of the pressure-bonded recording material and second information on a folding shape of the pressure-bonded recording material, which are inputted by the input portion.

### BACKGROUND

### Field of the Technology

The present disclosure relates to an image forming apparatus, such as a printer, a copying machine, a facsimile machine, or a multi-function machine, utilizing electrophotography.

### Description of the Related Art

Conventionally, the image forming apparatus capable of forming an image, with toner, on a pressure-bonding print (printed matter) excellent in confidentiality of information has been proposed (Japanese Laid-Open Patent Application (JP-A) 2014-35454). As the pressure-bonding print, it is possible to cite, for example, a pressure-bonding postcard such that opposing surfaces each on which personal information is formed as an image are superposed and pseudo-bonded together, and a user cannot read the personal information until the opposing surfaces pseudo-bonded together are peeled off from each other. Here, pseudo-bonding refers to one form of bonding such that the recording material is peelable after the bonding and is not readily bonded again after the peeling, and in the following, herein, the “pseudo-bonding” is referred to as “pressure bonding”.

The pressure-bonding postcard is capable of forming images on, in addition to a front surface and a back surface which are exposed to an outside thereof in a pressure-bonded state in which a postcard for the pressure-bonded postcard is bent and pressure-bonded, a surface thereof constituting an inside thereof in the power source state (this surface is also referred to as a superposed surface), and is capable of increasing an information amount more than an ordinary postcard. The image formed on the superposed surface of the pressure-bonding postcard in the pressure-bonded state (hereinafter, referred to as a pressure-bonded postcard for being distinguished from the pressure processing postcard before the pressure bonding (processing)) is not visually recognized until the superposed surface is peeled off, so that the pressure bonding postcard is widely utilized as a print medium for direct mail for in expensively mailing highly confidential information or much information. In the case where the image is formed on the pressure processing postcard, an image such as a predetermined text or the like is formed on a surface for the superposed surface and then pressure-bonded, and after the pressure bonding, an image such as an address (addressee) is separately formed on a front surface or a back surface of the pressure-bonded postcard in many instances.

However, conventionally, in the case where the toner image is formed on the front surface or the back surface of the bend and pressure-bonded recording material, there was a liability such that an image defect occurs in the toner image on the superposed surface or the toner image on the front surface or the back surface.

### SUMMARY

According to an aspect of the present disclosure, there is provided an image forming apparatus comprising: an image forming portion configured to form a toner image on a recording material; a fixing portion configured to fix the toner image, on the recording material, formed on the recording material by the image forming portion; an input portion configured to input information on the recording material; and a controller, wherein in a case where the controller executes an operation in a first mode in which the toner image is formed on a pressure-bonded recording material bent and pressure-bonded so that one surface of the recording material becomes an opposing inner surface, the controller controls the fixing portion on the basis of first information on a basis weight of the pressure-bonded recording material and second information on a folding shape of the pressure-bonded recording material, which are inputted by the input portion.

Further features of the present disclosure will become apparent from the following description of exemplary embodiments with reference to the attached drawings.

### BRIEF DESCRIPTION OF THE DRAWINGS

Part (a) of FIG. 1 is a schematic view showing a structure of an image forming apparatus, and part (b) of FIG. 1 is a schematic view showing a structure of a secondary transfer portion.

FIG. 2 is a control block diagram showing a control constitution of the image forming apparatus.

FIG. 3 is a schematic view showing a kind of folding processing and a base material layer number.

Part (a) of FIG. 4 is a sectional view showing a state before two-fold processing, part (b) of FIG. 4 is a plan view showing the state before the two-fold processing, part (c) of FIG. 4 is a perspective view showing a state during the two-fold processing, and part (d) of FIG. 4 is a sectional view showing a state after the two-fold processing.

FIG. 5 is a flowchart showing image forming processing in a first embodiment.

FIG. 6 is a schematic view showing an “accommodating portion selecting screen”.

FIG. 7 is a schematic view showing a “recording material (sheet) kind selecting screen”.

Parts (a) and (b) of FIG. 8 are schematic views each showing a “pressure-bonded postcard setting screen”, in which part (a) shows a selection state of a “kind of folding”, and part (b) shows a selectable state of the “kind of folding”.

Part (a) of FIG. 9 is a sectional view showing a state before outward three folding (fold processing), part (b) of FIG. 9 is a sectional view showing a state during the outward three folding, and part (c) of FIG. 9 is a sectional view showing a state after the outward three folding.

Parts (a) and (b) of FIG. 10 are schematic views each showing another example of a “pressure-bonded postcard setting screen”, in which part (a) of FIG. 10 is a schematic view showing a selecting state of a “recording material layer number by folding”, and part (b) of FIG. 10 is a schematic view showing a selectable state of the “recording material layer number by folding”.

FIG. 11 is a flowchart showing secondary transfer voltage control.

FIG. 12 is a flowchart showing image forming processing in a second embodiment.

### DESCRIPTION OF THE EMBODIMENTS

### First Embodiment

### <Image Forming Apparatus>

In the following, a first embodiment will be described. First, an image forming apparatus 100 of this embodiment will be described using parts (a) and (b) of FIG. 1. As shown in part (a) of FIG. 1, the image forming apparatus 100 is an electrophotographic full-color printer of an intermediary transfer type including image forming stations Pa, Pb, Pc, and Pd (image forming units) for forming images of yellow, magenta, cyan, and black, respectively. The image forming apparatus 100 forms a toner image on a recording material S on the basis of image data sent from an original reading device (not shown) connected to an apparatus main assembly or from an external device 900 such as a personal computer connected to the apparatus main assembly so as to be capable of inputting and outputting data. Incidentally, the image forming apparatus 100 may also be a monochromatic printer provided with only one image forming station Pd for black.

The image forming stations Pa, Pb, Pc, and Pd are juxtaposed along a movement direction of an intermediary transfer belt 130 in the image forming apparatus main assembly. The intermediary transfer belt 130 is stretched by a plurality of rollers (13, 14, 15) and is rotated. Then, the intermediary transfer belt 130 as an image bearing member carries and conveys, to a secondary transfer portion 200, a toner image primary-transferred in a manner described later. The secondary transfer portion 200 includes an inner secondary transfer roller 14 and an outer secondary transfer roller 11. By the inner secondary transfer roller 14 stretching the intermediary transfer belt 130 and an outer secondary transfer roller 11 disposed in a position opposing the inner secondary transfer roller 14 through the intermediary transfer belt 130, a secondary transfer nip N1 where the toner image on the intermediary transfer belt 130 (image bearing member) is transferred onto the recording material S is formed. On a side downstream of the secondary transfer portion 200 with respect to a recording material conveying direction, a fixing device 8 is provided.

At a lower portion of the image forming apparatus 100, a cassette 10 in which recording materials S are accommodated is provided. The recording material S is supplied from the cassette 10 and is conveyed toward a registration roller pair 12 by a feeding roller 16. Thereafter, the registration roller pair 12 is started to be rotated in synchronism with the toner image formed on the intermediary transfer belt 130, so that the recording material S is conveyed toward the secondary transfer portion 200. A plurality of cassettes 10 capable of accommodating the recording materials S different in size and thickness may be provided, and in that case, the recording material S selected from either one of the plurality of cassettes 10 by a user is supplied. Incidentally, the recording material S is not limited to the recording material S accommodated in the cassette 10, but the recording material S accommodated in a manual feeding tray 160 may also be supplied. Further, a constitution in which as an option, an unshown sheet (paper) feeding apparatus as a casing different from the image forming apparatus 100 is connected to the image forming apparatus 100 and in which the recording material S accommodated in the sheet feeding apparatus is supplied to the image forming apparatus 100 may also be employed. Incidentally, the recording material S is typically paper (sheet), but is not limited thereto, and synthetic paper, such as waterproof paper, formed of a resin, a plastic sheet such as an OHP sheet, a cloth, and the like are used in some instances.

The four image forming stations Pa, Pb, Pd, and Pd provided in the image forming apparatus 100 have a substantially same constitution except that development colors are different from each other. Accordingly, in this embodiment, as a representative, the image forming portion Pa for yellow will be described, and other image forming stations Pb, Pc, and Pd will be omitted from description.

In the image forming station Pa, a cylindrical photosensitive drum 3a is provided. The photosensitive drum 3a is rotationally driven in a predetermined direction. At a periphery of the photosensitive drum 3a, a charging device 2a, an exposure device La, a developing device 1a, a primary transfer roller 24a, and a drum cleaning device 4a are provided.

A process for forming, for example, a full-color image by the image forming apparatus 100 will be described. First, when an image forming operation is started, a surface of the rotating photosensitive drum 3a is electrically charged uniformly by the charging device 2a. The charging device 2a is a corona charger or the like for charging the photosensitive drum 3a to a uniform negative dark-portion potential by irradiating the photosensitive drum 3a with charge particles with corona discharge, for example. Then, the photosensitive drum 3a is subjected to scanning exposure to laser light which is emitted from the exposure device La and which corresponds to an image signal. By this, an electrostatic latent image depending on the image signal is formed on the surface of the photosensitive drum 3a. The electrostatic latent image formed on the surface of the photosensitive drum 3a is developed into a toner image which is a visible image by a developer, containing toner and a carrier, accommodated in the developing device 1a.

In the case of this embodiment, the developing device 1a uses, as the developer, a two-component developer containing non-magnetic toner and a magnetic carrier. The toner contains a binder resin, a colorant, and a parting agent (wax). As the binder resin, a known binder resin can be used. For example, it is possible to use resin materials such as a vinyl copolymer represented by a styrene-(meth)acrylic copolymer, a polyester resin, a hybrid resin obtained by chemically bonding a vinyl copolymer unit and a polyester unit to each other, an epoxy resin, a styrene-butadiene copolymer, and the like. As the colorant, it is possible to use known colorants for yellow, magenta, cyan, and black, respectively.

As the parting agent, for example, it is possible to cite aliphatic hydrocarbon wax such as low-molecular weight polyethylene, low-molecular weight olefin copolymer wax, microcrystallin wax, Fischer-Tropsch wax, and paraffin wax; oxide of aliphatic hydrocarbon wax such as oxidized polyethylene wax; their block copolymers; waxes principally containing fatty acid esters such as carnauba wax and montanic acid ester wax; ester wax which is synthetic reaction product between higher aliphatic acid, such as behenyl behenate or behenyl stearate, and higher alcohol; fatty acid esters a part or all of which is deoxidized, such as deoxidized carnauba wax; and the like.

The toner image formed on the photosensitive drum 3a is primarily transferred onto the intermediary transfer belt 130 in a primary transfer nip formed between the intermediary transfer belt 130 and the photosensitive drum 3a opposing the primary transfer roller 24a. At this time, to the primary transfer roller 24a, a primary transfer voltage is applied. Toner remaining on the surface of the photosensitive drum 3a after the primary transfer is removed by the drum cleaning device 4a.

Such an operation is sequentially performed in the image forming stations Pa, Pb, Pc, and Pd for yellow, magenta, cyan and black, respectively, so that four color toner images are superposed on the intermediary transfer belt 130. Thereafter, in synchronism with toner image forming timing, the recording material S accommodated in the cassette 10 is conveyed to the secondary transfer portion 200. Then, by applying a secondary transfer voltage to the outer secondary transfer roller 11, the toner images for a full-color image formed on the intermediary transfer belt 130 are collectively secondary-transferred onto the recording material S. Toner remaining on the intermediary transfer belt 130 on the recording material S after the secondary transfer is removed by a belt cleaning device 25. Incidentally, in the case of this embodiment, an image forming portion 150 capable of forming the toner images on the recording material S is constituted by the image forming stations Pa to Pd, the intermediary transfer belt 130, the rollers (13, 15), the secondary transfer portion 200, and the like.

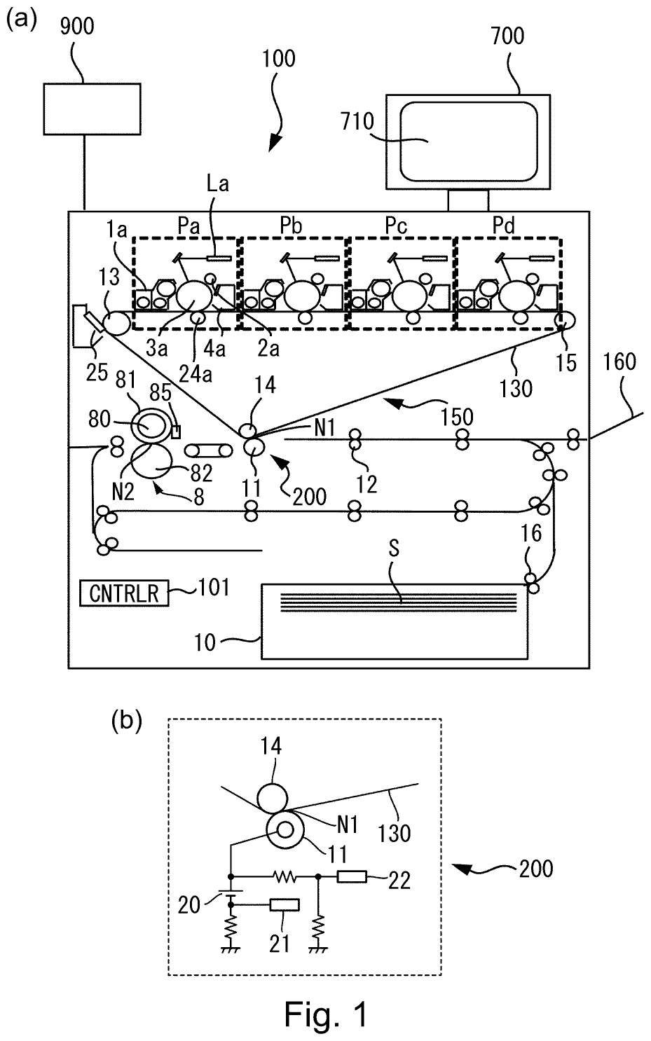

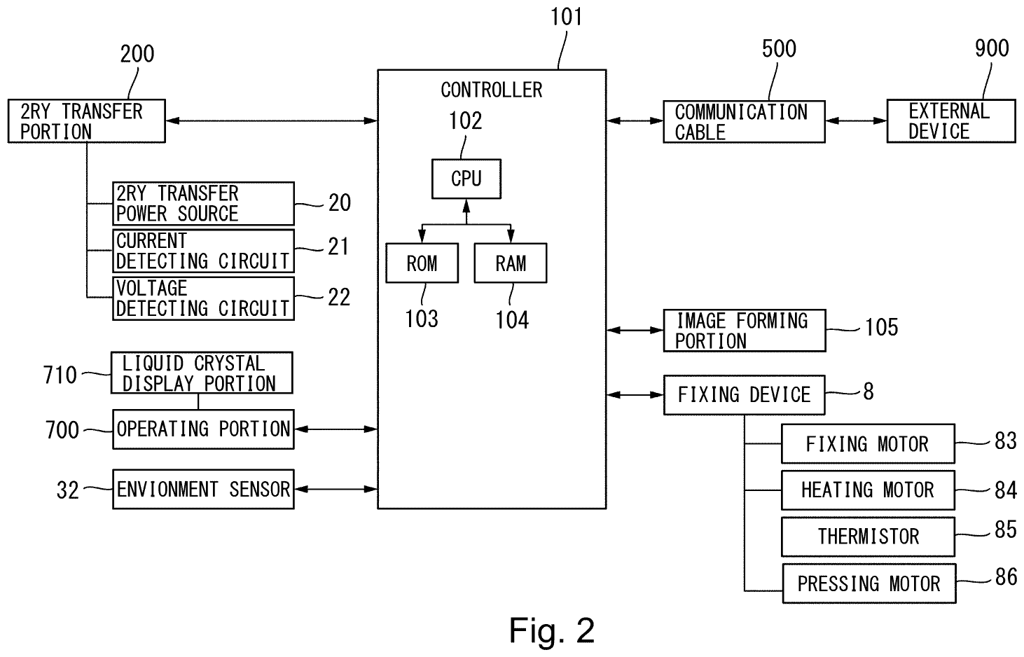

The recording material S on which the toner images are formed is conveyed toward the fixing device 8 as a fixing portion. The fixing device 8 includes a fixing roller 81 as a first rotatable member and a pressing roller 82 as a second rotatable member. The pressing roller 82 forms a fixing nip N2 in which the toner image is fixed by applying heat and pressure while nipping and conveying the recording material S in contact with the fixing roller 81. In the fixing roller 81, a heater 84 as a heating portion for heating the fixing roller 81 is provided, and a thermistor 85 for detecting a temperature of the fixing roller 81 is provided outside the fixing roller 81. In the case of this embodiment, the pressing roller 82 is disposed so as to be capable of pressing by the fixing roller 81 by a pressing motor 86 (see FIG. 2), and depending on that the fixing roller 81 is rotationally driven by a fixing motor 83 (see FIG. 2) as a rotation driving portion, the pressing roller 82 is rotated by the fixing roller 81 at the same speed as a rotational speed of the fixing roller 81.

In the fixing device 8, when the fixing roller 81 passes through the fixing nip N2 formed by being pressed by the pressing roller 82, thermal energy is imparted to an unfixed toner image on the recording material S, whereby the unfixed toner image is fixed on the recording material S. In this embodiment, in accordance with a fixing condition (tables 1 and 2 described later) set depending on a basis weight of the recording material S, the thermal energy imparted to the unfixed toner image changes. The recording material S on which the toner image is fixed is discharged to an outside of the image forming apparatus 100 after one side printing or double side printing. Incidentally, in this embodiment, the fixing device 8 using the fixing roller 81 and the pressing roller 82 was described as an example, but the fixing device 8 is not limited thereto, and may also be a fixing device using a fixing belt having an endless belt shape and a pressing belt.

### <Secondary Transfer Portion>

As shown in part (b) of FIG. 1, to the outer secondary transfer roller 11, a secondary transfer power source 20 of which output voltage is variable is connected. The inner secondary transfer roller 14 is electrically grounded (connected to the ground). When the recording material S passes through the secondary transfer nip N1, to the outer secondary transfer roller 11, a secondary transfer voltage which is a DC voltage of a polarity opposite to a normal charge polarity of the toner is applied by the secondary transfer power source 20. With the application of the secondary transfer voltage, a secondary transfer current flows through the secondary transfer nip N1, so that the toner image on the intermediary transfer belt 130 is secondarily transferred onto the recording material S. Through the secondary transfer nip N1, for example, a secondary transfer current of “+20 to +80 μA” flows.

In this embodiment, in order that the voltage applied to the outer secondary transfer roller 11 becomes a predetermined voltage, the secondary transfer portion 200 is subjected to constant-voltage control on the basis of information on electric resistance (principally, an electric resistance of the outer secondary transfer roller 11) acquired in a state in which there is no recording material S in the secondary transfer nip N1. For that purpose, to the secondary transfer power source 20, a current detecting circuit 21 for detecting the secondary transfer current flowing through the secondary transfer nip N1 and a voltage detecting circuit 22 for detecting an output voltage of the secondary transfer power source 20 are connected. The secondary transfer power source 20, the current detecting circuit 21, and the voltage detecting circuit 22 are provided, for example, in the same high-voltage substrate.

The outer secondary transfer roller 11 is constituted by including a core metal and an elastic layer formed with an ion-conductive foam rubber (NBR) around the core metal. For example, an outer diameter of the outer secondary transfer roller 11 is “24 mm”, and surface roughness Rz of the outer secondary transfer roller 11 is “6.0 to 12.0 μm”.

An electric resistance value of the outer secondary transfer roller 11 is “1×10⁵ to 1×10⁷Ω” in the case where the electric resistance value was measured under application of a voltage of “2 kV” in an N/N (23° C./50% RH) environment. A hardness of the elastic layer is about “30 to 40°” in terms of Asker-C hardness. A width of the outer secondary transfer roller 11 with respect to a longitudinal direction (rotational axis direction) is about “310 to 340 mm” and is wider than a maximum width of the recording material S of which conveyance is ensured by the image forming apparatus 100. The recording material S is conveyed on a center(-line) basis with respect to the longitudinal direction of the outer secondary transfer roller 11, and therefore, all the recording materials each of which conveyance is ensured by the image forming apparatus 100 pass through within a length range of the outer secondary transfer roller 11 in the longitudinal direction. By this, it becomes possible that the image forming apparatus 100 stably conveys recording materials S of various sizes and that toner images are stably transferred onto the recording materials S of various sizes.

The intermediary transfer belt 130 is an endless belt having a three-layer structure consisting of a resin layer, an elastic layer, and a surface layer from an inner peripheral surface side toward an outer peripheral surface side. As a resin material constituting the resin layer, polyimide, polycarbonate, or the like can be used. A thickness of the resin layer may suitably be, for example, “70 to 100 μm”. As an elastic material constituting the elastic layer, an urethane rubber, a chloroprene rubber, or the like can be used. A thickness of the elastic layer may suitably be, for example, “200 to 300 μm”.

As a material of the surface layer, a material by which a depositing force of the toner onto the surface of the intermediary transfer belt 130 is decreased and by which the toner is easily transferred onto the recording material S in the secondary transfer portion 200 is desired. For example, it is possible to use one or two or more kinds of resin materials such as polymethane, polyester, epoxy resin, and the like. Or, it is possible to use one or two or more kinds of elastic materials, such as elastic materials (elastic material rubber, elastomer), butyl rubber, and the like. Further, materials obtained by that in the above-described materials, one or two or more kinds of powder or particles of a material for reducing surface energy and for enhancing a lubricating property, for example, fluorine-containing resin, or one or two or more kinds of these powder and particles different in particle sizes are dispersed can be used. Incidentally, a thickness of the surface layer may suitably be “5 to 10 μm”. An electric resistance of the intermediary transfer belt 130 is adjusted by adding thereto an electroconductive agent for electric resistance adjustment, such as carbon black, and preferably, volume resistance of the intermediary transfer belt 130 is 1×10⁹ to 1×10¹⁴ Ω·cm.

### <Controller>

The image forming apparatus 100 includes a controller 101, and the controller 101 controls the image forming apparatus 100, so that the toner image is formed on the recording material S. Therefore, a control constitution of the image forming apparatus 100 will be described using FIG. 2 while making reference to FIG. 1. Incidentally, to the controller 101, in addition to the devices illustrated in FIG. 2, various devices such as sensors and power sources may be connected.

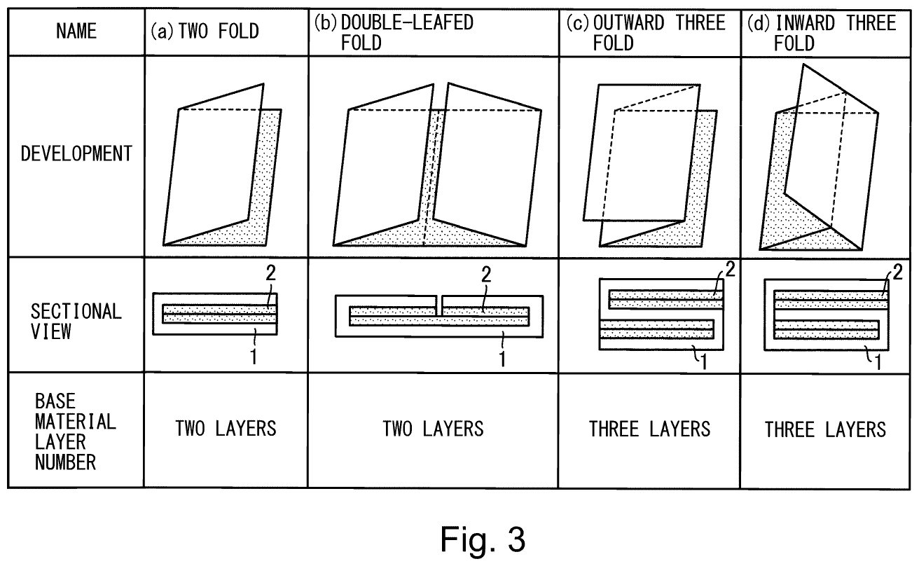

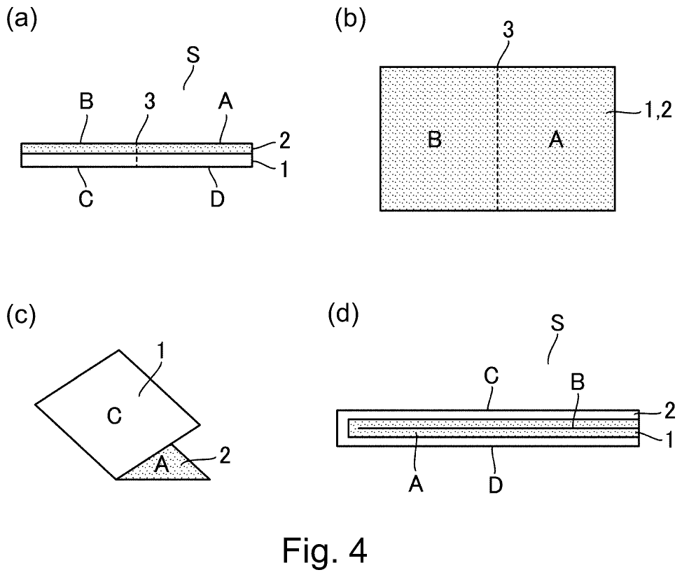

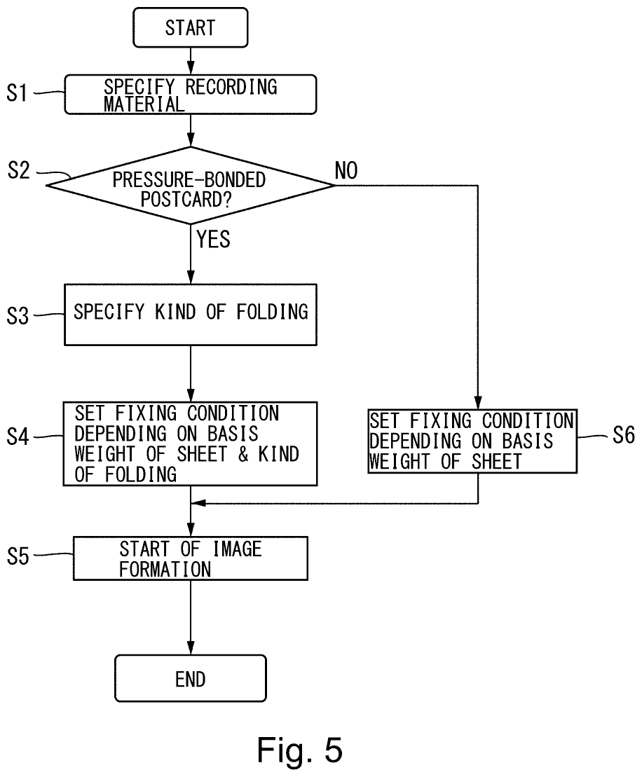

As shown in FIG. 2, the controller 101 is connected to the external device 900 such as the personal computer (PC) so as to be capable of communicating operation instructions, various data, and the like to the external device 900 through a communication cable 500. The controller 101 includes a CPU 102 (central processing unit), a ROM 103 (read only memory), and a RAM 104 (random access memory). In the ROM 103 and the RAM 104, although described later, various programs for a “image forming processing” (see FIG. 5) and various data such as a base material layer number (recording material layer number, see FIG. 3) associated in advance for each “kind of folding”, and “setting table data (tables 1 and 2) and the like are stored. Incidentally, the RAM 104 is also capable of temporarily storing a calculation (computation) processing result or the like with execution of the various programs.

The image forming apparatus 100 includes an operating portion 700 including, for example, a liquid crystal display portion 710, and the operating portion 700 is connected to the controller 101. The operating portion 700 is capable of displaying various programs, various data or various screens described later on the liquid crystal display portion 710. The operating portion 700 as an input portion may be, for example, a touch panel or the like operable by the user and is capable of receiving input of a start of the various programs such as an “image forming job” depending on a touch operation by the user and input of various pieces of information such as information on the recording material S. Incidentally, the information on the recording material S includes in addition to arbitrary pieces of information capable of discriminating the recording materials S, such as attributes based on general features such as plain paper, thick paper, thin paper, glossy paper, and coated paper; a manufacturer: a brand; a product number; a basis weight; a thickness; and the like, features of the pressure-bonded postcard described later, such as a basis weight, a manner of folding, a base material layer number depending on the manner of folding, and the like.

Further, to the controller 101, the secondary transfer power source 20, the current detecting circuit 21, and the voltage detecting circuit 22 are connected. As described above, the secondary transfer power source 20 is subjected to the constant-voltage control, and applies the secondary transfer voltage to the outer secondary transfer roller 11. Further, to the controller 101, a temperature/humidity sensor 32 is connected. The temperature/humidity sensor 32 as a detecting portion is disposed in the apparatus main assembly for detecting a temperature and a humidity in the apparatus main assembly of the image forming apparatus 100. The temperature and the humidity detected by the temperature/humidity sensor 32 are inputted to the controller 101, and on the basis of the temperature and the humidity detected by the temperature/humidity sensor 32, the controller 101 acquires a water content (moisture content, absolute water content) in the apparatus main assembly of the image forming apparatus 100.

The user is capable of inputting a start of the “image forming job” from the operating portion 700 and is capable of setting for printing an image on the pressure-bonded postcard. In the case where the “image forming job” is inputted, the CPU 102 is capable of executing “image forming processing (program)” stored in the ROM 103. To the controller 101, the fixing motor 83, the heater 84, the thermistor 85, and the pressing motor 86 are connected, so that depending on the recording material S to be conveyed, the controller 101 is capable of changing a control temperature, i.e., a fixing temperature of the heater 84, a speed of the fixing motor 83 (conveying speed of the recording material S), and a pressing force (pressure) of the pressing motor 86. The control temperature of the heater 84 is set depending on the recording material S so that the fixing temperature of the fixing device 8 becomes a temperature such that optimum fixing property and image (color tint, glossy feeling) can be obtained.

The image forming apparatus 100 executes a job (print operation) which is a series of operations which is started by a single start instruction (print instruction) and in which the image is formed and outputted on a single recording material P or a plurality of recording medium S. The job includes an image forming step, a pre-rotation step, a sheet (paper) interval step in the case where the images are formed on the plurality of recording material S, and a post-rotation step, in general. The image forming step is period in which formation of an electrostatic image for the image formed and outputted on the recording material S, formation of the toner image, primary transfer of the toner image and secondary transfer of the toner image are carried out in actuality, and during image formation (image forming period) refers to this period. The pre-rotation step is a period in which a preparatory operations, before the image forming step, from an input of the start instruction until the image is started to be actually formed is performed. The sheet interval step is a period corresponding to an interval between a recording material S and a subsequent recording material S when the images are continuously formed on the plurality of recording materials S (continuous image formation). The post-rotation step is a period in which a post-operation (preparatory operation) after the image forming step is performed. During non-image formation (non-image formation period) is a period other than the period of the image formation and includes the pre-rotation step, the sheet interval step, the post-rotation step and further includes a pre-multi-rotation step which is a preparatory operation during turning-on of a main switch (power source) of the image forming apparatus 100 or during restoration from a sleep state. Incidentally, the shape state is, a state in which supply of electric power to elements of the image forming apparatus 100, other than a part of the element, such as a part of the controller 101 is stopped.

### <Pressure-Bonded Postcard>

Next, the pressure-bonded postcard as a pressure bonding-processed recording material will be described. In this embodiment, the pressure-bonded postcard is used as the recording material S which is an image forming object. However, the “pressure-bonded postcard” is an example, and a size of the recording material S bent and pressure-bonded is not limited to a size of a postcard.

The pressure-bonded postcard is prepared by a pressure bonding processing apparatus (not shown) for performing pressure bonding such that the recording material S is bent (folded) and pressure-bonded, but as a type for performing the pressure-bonding, it is possible to cite a pasting type, a varnish type, a film type, for example. The pasting type is a type in which the pressure-bonding is performed by applying a pressure-sensitive adhesive onto the recording material S and then by applying heat and pressure to the recording material S. The varnish type is a type in which the pressure-bonding is performed by applying a UV curable varnish onto the recording material S and then by applying heat and pressure to the recording material S while irradiating the varnish with UV radiation. The film type is a type in which the pressure-bonding is performed by inserting a heat-sensitive pressure bonding film between superposed opposite surfaces of the recording material S and then by applying heat and pressure to the recording material S.

In FIG. 3, pressure-bonded postcards each in a representative folding manner (kind of folding processing) are shown. In FIG. 3, in order from the left, pressure-bonded postcards of two fold (V fold), double-leafed fold, outward three fold, and inward three fold are shown, and developments and sectional views thereof are shown. The pressure-bonded postcard comprises a pressure-bonding sheet, and the pressure-bonding sheet includes a base material 1 and an adhesive layer 2. The adhesive layer 2 of the pressure-bonding sheet is folded inward in a valley and pressure-bonded, so that the pressure-bonded postcard is prepared. The base material 1 of the pressure-bonding sheet is not particularly limited when the base material 1 is a material such that the adhesive layer 2 is capable of being formed on at least one surface thereof, and it is possible to cite, for example, high-quality paper, medium-quality paper, coated paper, synthetic paper, resin media, and the like. However, it is desirable that the base material 1 is opaque from a viewpoint of confidentially.

The adhesive layer 2 of the varnish type is for the purpose of such that a UV curable resin is applied onto a surface of the base material 1 on which an image is printed in advance and is cured by UV irradiation, and thereafter the pressure-bonding sheet is folded and pressure-bonded under application of heat and pressure. Here, for example, in the case where the plain paper is used as the base material 1 and is subjected to varnish processing, varnish easily permeates an inside of the plain paper, and the varnish permeated the inside of the plain paper is not sufficiently irradiated with UV rays. Then, a degree of curing is not sufficient, and therefore, there was a liability that an adhesive property of the varnish is low and the varnish is peeled off from the base material. Further, there was a liability that the pressure-bonded postcard to be prepared is lowered in quality due to a small resulting from the varnish and the sense of touch (for example, sticky feeling). Therefore, as the base material 1, it is desirable that either one of the coated paper, the resin media, and the synthetic paper, which are capable of being subjected to the varnish processing is selected.

The adhesive layer 2 of the film type is for the purpose of such that the base material 1 on which an image is printed in advance is folded and a peelable two-layer pressure bonding film is inserted into between the folded base material 1, and then the base material 1 between which the pressure bonding film is inserted is pressure-bonded under application of heat and pressure.

The adhesive layer 2 of a pre-paste type or a post-paste type includes a pressure-sensitive adhesive containing an adhesive base material and an adhesive force adjusting agent and is for the purpose such that the adhesive layer 2 is formed on the base material 1 before or after image formation, and then folded and pressure-bonded under application of heat and pressure. As the adhesive base material, for example, a composition in which a natural rubber latex, a modified product thereof, a synthetic rubber latex, a synthetic resin, or the like is mixed is used, and the adhesive base material exhibits a pressure-sensitive adhesive force. The adhesive force adjusting agent is a fine-particulate filler including fine particles of a known wax such as a paraffin wax, silica, titanium oxide, calcium carbonate, or the like. Each of these materials is low in affinity for the adhesive base material, and adjusts the adhesive force of the pressure-sensitive adhesive.

Incidentally, even in either type, when an advantage of inexpensiveness of the pressure-bonded postcard than sealed letter in terms of transportation cost such as postage is taken into account, a basis weight of the recording material S including the base material 1 and the adhesive layer 2 in combination may desirably be, for example, “64 g/m² or more and 209 g/m² or less”.

The pressure-bonded postcard is pressure-bonded in a folded (bent) state, and therefore, the base material is superposed in a plurality of layers, so that compared with the pressure-bonding sheet, a thickness and a net basis weight of the pressure-bonded postcard are increased by those corresponding to the number of base material layers. As shown in FIG. 3, the number of base material layers is associated in advance with each “kind of folding” of two fold, double-leafed fold, outward three fold, and inward three fold. In the two fold and the double-leafed fold, the number of base material layers is “two layers”, and in the outward three fold and the inward three fold, the number of base material layers is “three layers”. In accordance with this number of base materials (base material layer number), the thickness and the heat basis weight of each of the pressure-bonded postcards of the two fold and the double-leafed fold become two times of the thickness and the net basis weight of the pressure-bonding sheet, and the thickness and the net basis weight of each of the pressure-bonded postcards of the outward three fold and the inward three fold become three times of the thickness and the net basis weight of the pressure-bonding sheet. Incidentally, the “kind of folding” is not limited to those shown in FIG. 3. As other kinds of folding, for example, there are inward four fold, outward four fold, and the like, each of which base material layer number is “four layers”.

Here, the pressure-bonded postcard can be delivered as second class mail (postcard) at a low cost by satisfying provisions prescribed in Articles 22 and 24 of Domestic Postal Regulations prescribed by Japan Post Co., Ltd. based on provisions of Articles 67 and 68 of Postal Law. In the above-described regulations, it is prescribed that a weight of a postcard main body is “2 g to 6 g”, so that of folding manners shown in FIG. 3, each of the pressure-bonding sheets used for the outward three fold and the inward three fold includes the base material superposed in three layers, and therefore is required to be made lighter (thinner) than the pressure-bonding sheet used for the two fold.

For easy understanding of description in this embodiment, first, the pressure-bonded postcard of the two fold will be described as an example. A preparation procedure of the pressure-bonded postcard of the two fold is shown in parts (a) to (d) of FIG. 4.

Paste surfaces A and B in parts (a) and (b) of FIG. 4 are surfaces each on which a toner image such as high confidential information or much information is capable of being formed. The pressure-bonding sheet such that the toner images are formed on the paste surfaces A and B thereof is folded in a valley so that the paste surfaces A and B become an inside, and is pressure-bonded in a state in which the paste surfaces A and B oppose each other.

On a front surface and a back surface (C and D of part (d) of FIG. 4) which one outer surfaces of the thus-prepared pressure-bonded postcard, for example, a toner image such as an address (addressee) is separately formed. Conventionally, when the toner images are formed on the front surface and the back surface of the pressure-bonded postcard, a fixing condition (see setting table data of a table 1 appearing hereinafter) depending on the net basis weight after the pressure bonding (processing) is set, and then fixing of the toner images has been performed by the fixing device 8. In the case of the pressure-bonded postcard of the two fold, the pressure-bonding sheet is pressure-bonded in a state in which the pressure-bonded postcard is superposed in two layers, and therefore, the net basis weight the pressure-bonded postcard is two times the basis weight of the pressure-bonding sheet (recording material before the pressure bonding) as described above.

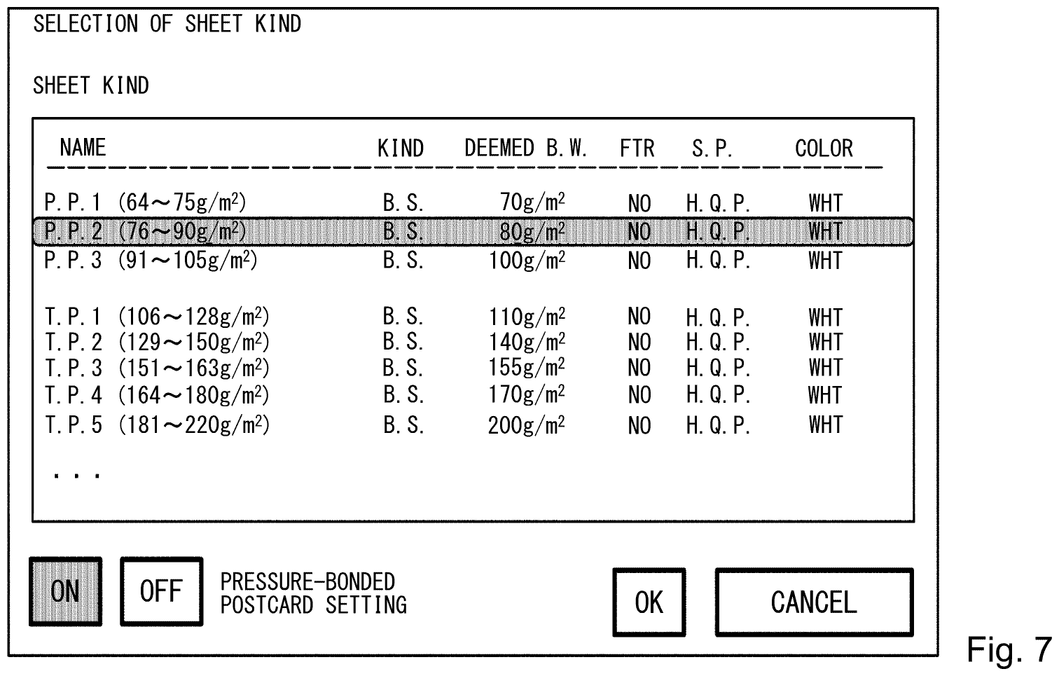

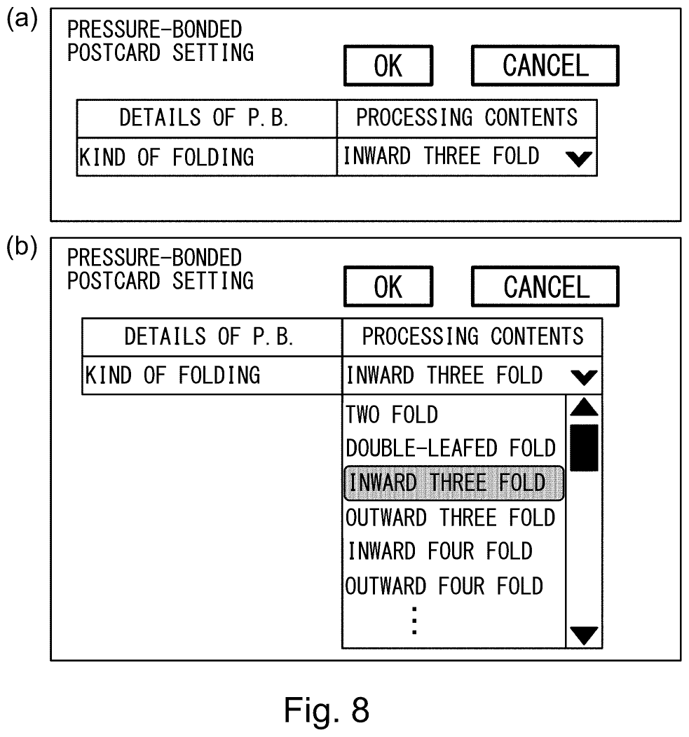

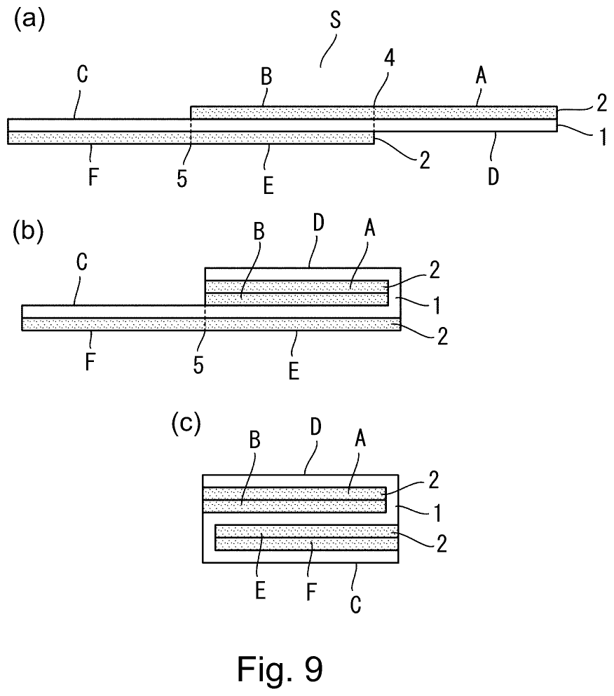

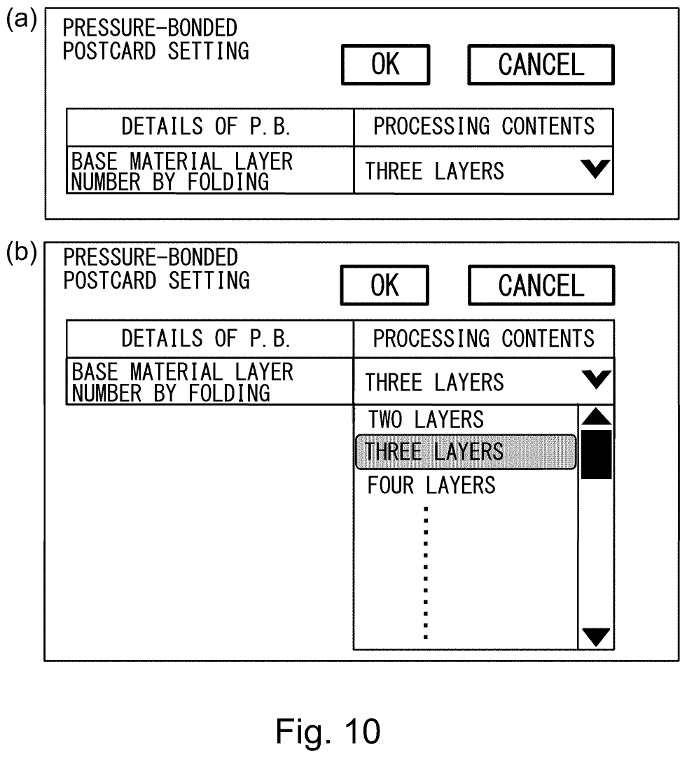

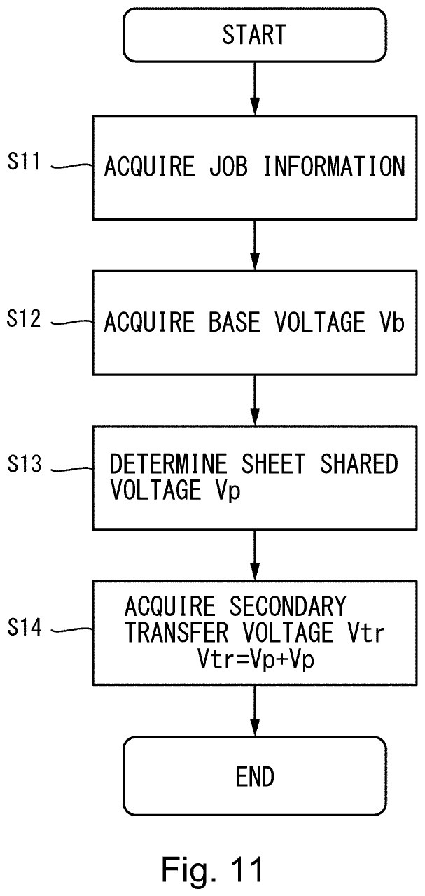

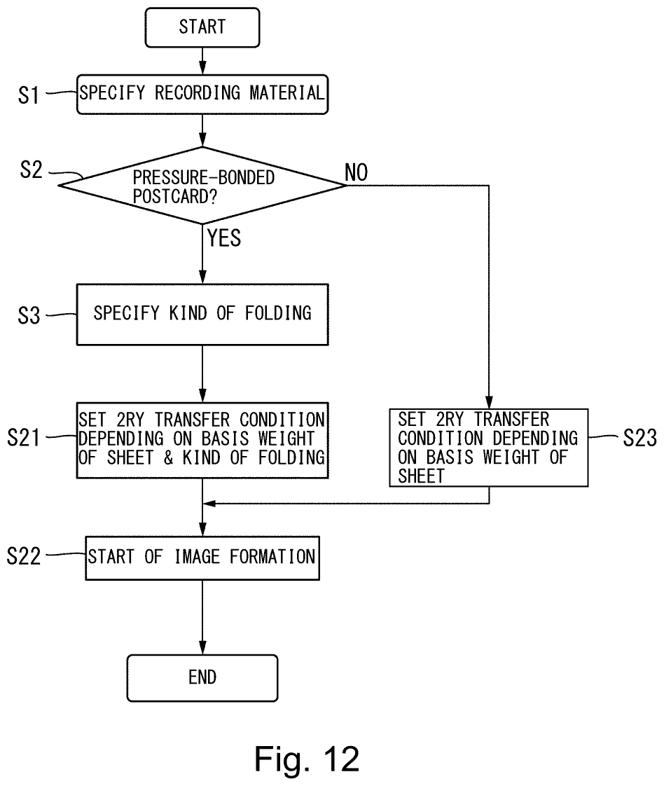

For example, in the case where the pressure-bonding sheet is “thick paper 1 (106 to 128 g/m²), when the toner images are formed on the paste surfaces A and B (superposed surfaces), the fixing device 8 is operated at “190° C., 200 mm/sec” (see thick paper 1 of the table 1). That is, an apparent basis weight used on control of the fixing device 8 is set to “110 g/m²) (see FIG. 7 described later), a control temperature of the heater 84 is set to “190° C.”, and a speed of the fixing motor 83 is set to “200 mm/sec”.

Thereafter, the pressure-bonding sheet is folded and pressure-bonded, so that the pressure-bonded postcard of the two fold is prepared. Conventionally, when the toner images are formed on the front surface and the back surface of the pressure-bonded postcard of the two fold, the fixing device 8 has been operated at “200° C., 200 mm/sec” (see thick paper 3, thick paper 4, thick paper 5 in table 1). That is, the net basis weight of the pressure-bonded postcard of the two fold becomes “220 (110×2) g/m²” which is two times of the apparent basis weight of the pressure-bonding sheet, so that a control temperature of the heater 84 is set to “200° C.” higher than “190° C.”, and the speed of the fixing motor 83 is set to “200 mm/sec”.

TABLE 1

| Name*¹ | BW*² (g/m²) | CT*³ (° C.) | CS*⁴ (mm/sec) |
|---|---|---|---|
| TNP1 | 52 to 63 | 150 | 200 |
| PP1 | 64 to 75 | 160 | 200 |
| PP2 | 76 to 90 | 170 | 200 |
| PP3 | 91 to 105 | 180 | 200 |
| TKP1, 2 | 106 to 150 | 190 | 200 |
| TKP3, 4, 5 | 151 to 220 | 200 | 200 |
| TKP6 | 221 to 300 | 200 | 150 |
| TKP7 | 301 to 400 | 200 | 100 |

*¹TNP1 is thin paper 1. PP1 is plain paper 1. PP2 is plain paper 2. PP3 is plain paper 3. TKP1, 2 are thick paper 1 and thick paper 2. TKP3, 4, 5 are the thick paper 3, thick paper 4, and thick paper 5. TKP 6 is thick paper 6. TKP7 is thick paper 7.
*²“BW” is the basis weight.
*³“CT” is the control temperature.
*⁴“CS” is the conveying speed.

Incidentally, in the conventional case, there was a liability that the toner of the toner image formed early on the superposed surfaces is melted again, and the melted toner is transferred from one surface to the other surface during unsealing of the pressure-bonded postcard, thus causing an image defect. Therefore, in the case where the toner images are formed on the front surface and the back surface of the pressure-bonded postcard such that the toner images have already been formed on the superposed surfaces, there is a need that the toner images are made hard to be transferred during the unsealing of the pressure-bonded postcard. In the following, image forming processing for realizing it, in this embodiment will be described.

### <Image Forming Processing>

The “image forming processing” in the first embodiment (this embodiment) will be described using FIGS. 5 and 8 while making reference to FIG. 2. The “image forming processing” in this embodiment is started by the controller 101 (specifically, the CPU 102) for example, in the case where the image forming job is inputted from the operating portion 700 or in the case where the image forming job is received from the external device 900.

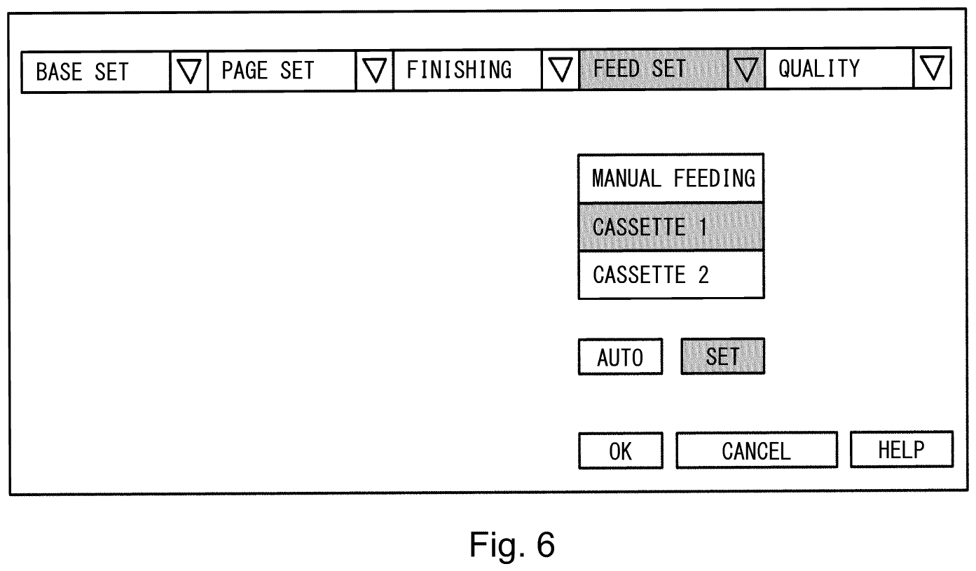

As shown in FIG. 5, the controller 101 specifies the recording material S which is an image forming object selected in advance by the user and stored in the RAM 104 (S1). Then, the controller 101 discriminates whether or not the specified recording material S which is the image forming object is the “pressure-bonded postcard” (S2). In a “accommodating portion selecting screen” shown in FIG. 6, the user is capable of setting either one of “manual feeding”, “cassette 1” and “cassette 2”, from sheet (paper) feeding setting, as an accommodating portion in which recording materials S which are the image forming objects are accommodated. By the “accommodating portion selecting screen” displayed on the liquid crystal display portion 710, the user is capable of selecting the recording material S which is not pressure-bonded (hereinafter, this recording material S is referred to as a normal recording material S) and an accommodating portion in which pressure-bonded postcards each in which images have already been formed on the superposed surfaces are accommodated. Further, from a “recording material (sheet) kind selecting screen” shown in FIG. 7, the user has already selected the recording material S which is the image forming object in advance. The “recording material kind selecting screen” shown in FIG. 7 is displayed on the liquid crystal display portion 710 an operation, by the user, of a “setting” button of the “accommodating portion selecting screen” shown in FIG. 6.

In the “recording material kind selecting screen” shown in FIG. 7, the user is capable of selecting “plain paper (P.P.) 1,2,3”, “thick paper (T.P.) 1,2,3,4,5”, and the like, different in basis weight, as a “recording material kind”. In the case where the images are formed on the front surface and the back surface of the pressure-bonded postcard, as the “recording material kind”, the user selects the recording material S corresponding to the pressure-bonding sheet used for preparation of the pressure-bonded postcard. For example, in the case of plain paper of “95 g/m²) in basis weight of the pressure-bonding sheet, the user selects “plain paper 3 (91 to 105 g/m², 91 g/m² or more and 105 g/m² or less”. The apparent (deemed) basis weight in this case is “100 g/m²) as shown in FIG. 7.

Further, the user operates an “ON” button of “pressure-bonded postcard setting”, whereby the “pressure-bonded postcard” folded and pressure-bonded so that one surface thereof becomes opposing inner surfaces is selected as the recording material S which is the image forming object. In the case where the “pressure-bonded postcard” is selected, an operation mode of the image forming apparatus 100 is set to a “pressure-bonded postcard mode” (first mode). In the case where an “OFF” button of the “pressure-bonded postcard setting is operated, a normal recording material S (including a recording material S, before the pressure bonding, which is not folded) is selected as the recording material S which is the image forming object. In the case where the normal recording material S is selected, the operation mode of the image forming apparatus 100 is set to a “normal printing mode” (second mode).

Returning to FIG. 5, in the case where the recording material S which is the image forming object is not the “pressure-bonded postcard (NO of S2), the controller 101 sets the fixing condition of the fixing device 8 depending on the basis weight of the normal recording material S selected by the user in the “recording material kind selecting screen” shown in FIG. 7 (S6). At this time, the controller 101 sets the fixing condition for the normal recording material S by making reference to the above-described setting table data of the table 1. For example, in the case where “thick paper 1 (106 to 128 g/m²) is selected as the recording material S from the “recording material kind selecting screen” (deemed basis weight: 110 g/m²) and the “OK” button of the “pressure-bonded postcard setting” is not operated, the controller 101 makes reference to the setting table data of the table 1 and sets the control temperature of the heater 84 to “190° C. (second temperature) and the speed of the fixing motor 83 to “200 mm/sec”. Then, the controller 101 starts an operation in the “normal printing mode” as formation of the image on the normal recording material S in accordance with the set fixing condition (S5). In the case of this embodiment, when the toner image is formed on the superposed surfaces of the recording material S before the pressure bonding, the operation in the “normal printing mode” is started.

On the other hand, in the case where the recording material S which is the image forming object is the “pressure-bonded postcard” (YES of S2), the controller 101 specifies the kind of folding (S3). The kind of folding is selected by the user in advance from the “pressure-bonded postcard setting screen 2 shown in parts (a) and (b) of FIG. 8, and is stored in the RAM 104. The “pressure-bonded postcard setting screen” shown in part (a) of FIG. 8 is displayed as a pop-up screen on the liquid crystal display portion 710 depending on the operation of the “ON” button of the “pressure-bonded postcard setting” shown in FIG. 7.

When “processing contents” corresponding to “details of pressure bonding” is operated by the user, a pull-down button as shown in part (b) of FIG. 8 is displayed. On the pull-down button, kind of folding (second information on folding shapes of the pressure-bonded postcard) such as the two fold, the double-leafed fold, the outward three fold, and the inward three fold is displayed in a selectable manner by the user. The user is capable of selecting the folding manner of the “pressure-bonded postcard” from the folding shapes displayed on the pull-down button. In part (a) of FIG. 8, a state in which the “inward three fold” is selected as the folding manner of the pressure-bonded postcard is shown.

Returning to FIG. 5, the controller 101 sets the fixing condition of the fixing device 8 depending on the basis weight of the recording material S selected by the user in the “recording material kind selecting screen” shown in FIG. 7 and the kind of folding selected by the user in the “pressure-bonded postcard setting screen” shown in parts (a) and (b) of FIG. 8 (S4). At this time, in accordance with the net basis weight of the pressure-bonded postcard, the controller 101 sets the fixing condition for the pressure-bonded postcard by making reference to a setting table data of a table 2, appearing hereinafter, which is prepared separately from the above-described table data of the table 1. The net basis weight of the pressure-bonded postcard (first information on the basis weight of the pressure-bonded recording material) is acquired by using the base material layer number (see FIG. 3) stored in the ROM 103 in advance in association with the “kind of folding” in accordance with the “kind of folding” selected in the “pressure-bonded postcard setting screen)”.

For example, in the case where “thick paper 1 (106 to 128 g/m²) is selected as the recording material S from the “recording material kind selecting screen” (deemed basis weight: 110 g/m²) and the kind of folding selected in the “pressure-bonded postcard setting screen” is the “two fold”, the base material layer number associated with the “two fold” is “two layers” (see FIG. 3), so that the net basis weight of the pressure-bonded postcard of the “two fold” becomes “220 g (110×2)”. Accordingly, the controller 101 makes reference to the setting table data of the table 2 below (the base material layer number of “2” and the basis weight of 151 or more and 220 or less), and sets the control temperature of the heater 84 to “170° C.” (first temperature) and sets the speed of the fixing motor 83 to “200 mm/sec”. Then, in accordance with the set fixing condition, the controller 101 starts an operation in the “pressure-bonded postcard mode” as an image forming mode for the pressure-bonded postcard (S5).

TABLE 2

| Name*¹ | LN*² | BW*³ (g/m²) | CT*⁴ (° C.) | CS*⁵ (mm/sec) |
|---|---|---|---|---|
| PBP | 2 | 106 to 150 | 160 | 200 |
| (TF) | 2 | 151 to 220 | 170 | 200 |
| | 2 | 221 to 300 | 180 | 200 |
| | 2 | 301 to 400 | 190 | 150 |
| PBP | 3 | 106 to 150 | 155 | 200 |
| (OTF) | 3 | 151 to 220 | 165 | 200 |
| | 3 | 221 to 300 | 175 | 200 |
| | 3 | 301 to 400 | 190 | 200 |

*¹“PBP” is the pressure-bonded postcard. “(TF)” is the two fold. “(OTF)” is the outward three fold.
*²“LN” is the layer number.
*³“BW” is the basis weight.
*⁴“CT” is the control temperature.
*⁵“CS” is the conveying speed.

The control temperature of the heater 84 in the fixing device 8 is set to a temperature at which the toner of each color is sufficiently mixed in color and desired gloss(iness) is exhibited without being peeled off from the recording material S. That is, when the control temperature of the heater 84 is lower than an optimum range, the gloss of the toner image lowers and the toner of each color is not mixed in color, so that a desired color tint cannot be exhibited. In addition, the toner is not sufficiently melted, so that the toner is liable to be peeled off from the recording material S. Therefore, the control temperature of the heater 84 is set to a temperature sufficiently higher than a temperature at which a toner fixing property is ensured.

As the pressure-bonding sheet for the two fold, for example, a pressure-bonding sheet (“POSTEX TWO FOLD”, paper thickness: about 0.12 mm, basis weight: about 128 g/m², manufactured by Toppan Forms Co., Ltd.) is used.

In the case where toner images (for example, maximum toner application amount: 1.2 mg/cm²) are formed and fixed on superposed surfaces of the pressure-bonding sheet, as described above, a fixing condition (190° C., 200 mm/sec) for a basis weight (110 g/m²) is set in accordance with the setting table data of the table 1.

On the other hand, on the front surface and the back surface of the pressure-bonded postcard, toner images of a postal code of an address, the address, and an addressee of the toner images are formed. For the toner images formed on the front surface and the back surface of the pressure-bonded postcard, the gloss and the color tint are not required than for the toner images formed on the superposed surfaces. That is, the toner images formed on the front surface and the back surface of the pressure-bonded postcard may only be required that a fixing property such that the pressure-bonded postcard is capable of withstanding delivery of the mail is ensured. In the case where the toner images (for example, the maximum toner application amount: 1.2 mg/cm²) are formed and fixed on the front surface and the back surface of the pressure-bonded postcard obtained by folding and pressure bonding the above-described pressure-bonding sheet “POSTEX TWO FOLD”, as described above, a fixing condition (170° C., 200 mm/sec) for a basis weight “220 g/m²” is set in accordance with the setting table data of the table 2. This temperature is lower than the control temperature (200° C.) for the basis weight “220 g/m²) based on the setting table data of the table 1. That is, the operation in the “pressure-bonded postcard mode” is performed, thermal energy imparted to the unfixed toner images is reduced by lowering the control temperature than when the operation in the “normal printing mode” is performed for the pressure-bonding sheet of a basis weight substantially equal to the net basis weight of the pressure-bonded postcard.

Next, the pressure-bonded postcard of the outward three fold will be described as an example. In parts (a) to (c) of FIG. 9, a preparation procedure of the pressure-bonded postcard of the outward three fold was shown. Each of paste surfaces A and B and paste surfaces E and F is a surface on which a toner image such as high confidential information or much information is capable of being formed. The pressure-bonding sheet such that the toner images are formed on the paste surfaces A and B is, as shown in part (b) of FIG. 9, folded inward in a valley and is pressure-bonded in a state in which the paste surfaces A and B constituting the superposed surfaces oppose each other. Further, the pressure-bonding sheet such that the toner images are formed on the paste surfaces E and F is, as shown in part (c) of FIG. 9, folded inward in a valley and is pressure-bonded in a state in which the paste surfaces E and F constituting the superposed surfaces oppose each other.

For the thus-prepared pressure-bonded postcard, the toner images such as the address are separately formed on the front surface and the back surface (C and D of part (c) of FIG. 9). Conventionally, when the toner images are formed on the front surface and the back surface of the pressure-bonded postcard, the fixing condition (see the above-described setting table data of the table 1) depending on the net basis weight after the pressure bonding is set, and fixing of the toner image was performed by the fixing device 8.

However, in the case of the pressure-bonded postcard of the outward three fold, the pressure-bonding sheet is folded in a state in which the pressure-bonding sheet is superposed in three layers, and therefore, as described above, the net basis weight of the pressure-bonded postcard becomes three times the basis weight of the pressure-bonding sheet. In the conventional constitution, also in the case of outward three fold, similarly as in the case of the two fold, the toner of the toner images formed on the superposed surfaces is melted again, and the melted toner is transferred from one surface to the other surface during unsealing of the pressure-bonded postcard, so that there was a possibility of an occurrence of an image defect.

As the pressure-bonded postcard of the outward three fold, for example, a pressure-bonding sheet (“POSTEX THREE FOLD”, paper thickness: about 0.08 mm, basis weight: about 80 g/m², manufactured by Toppan Forms, Co., Ltd.) is used.

In the case where the toner images (for example, the maximum toner application amount: 1.2 mg/cm²) are formed and fixed on superposed surfaces of this pressure-bonding sheet, “plain paper 2 (76 to 90 g/m²) is selected as the recording material S (deemed basis weight: “80 g/m²”), and the fixing condition (170° C., 200 mm/sec) is set in accordance with the setting table data of the table 1.

In the case where “plain paper 2 (76° to 90 g/m²) is selected as the recording material S and the selected kind of fold is “outward three fold”, the base material layer number of the “outward three fold” is “three layers”, so that the net basis weight of the pressure-bonded postcard of the “outward three fold” becomes “240 g/m² (80×3)”. In this embodiment, in the case where the toner images (for example, the maximum toner application amount: 1.2 mg/cm²) are formed and fixed on the front surface and the back surface of the pressure-bonded postcard obtained by folding and pressure bonding the above-described pressure-bonding sheet “POSTEX THREE FOLD”, a fixing condition (175° C., 200 mm/sec) for the basis weight “240 g/m²” is set in accordance with the setting table data of the table 2.

Incidentally, for example, in the case where the toner images are formed and fixed on the front surface and the back surface of the pressure-bonded postcard, of the “two fold”, of which net basis weight is “240 g/m²”, a fixing condition (180° C., 200 mm/sec) for the basis weight “240 g/m²) is set in accordance with the setting table data of the table 2. That is, in the case where the pressure-bonded postcards have the same net basis weight, the control temperature of the heater 84 is set to “180° C.” when the selected base material layer number is a first layer number (two layers) and is set to “175° C.” lower than control temperature set in the case of the first layer number when the selected base material layer number is a second layer number (three layers) larger than the first layer number (see the table 2).

As described above, in this embodiment, in the case where the operation in the “PBP mode” in which the toner images are formed on the front surface and the back surface of the pressure-bonded postcard is performed, the “pressure-bonded postcard setting screen” (see part (a) of FIG. 8) is displayed on the operating portion 700, and input of the “kind of folding”, in other words, “kind of pressure-bonded postcard” is prompted to the user. Then, on the basis of the “net basis weight” and the “base material layer number” of the pressure-bonded postcard depending on the “kind of folding” selected by the user, the setting of the control temperature of the heater 84 is changed (see the table 2). In the case where the operation in the “pressure-bonded postcard mode” is performed, the control temperature of the heater 84 is lowered than in the case where the operation in the “normal printing mode” is performed for the pressure-bonded postcard of a basis weight substantially equal to the net basis weight of the pressure-bonded postcard. That is, thermal energy imparted to the unfixed toner images is decreased. Thus, by decreasing the thermal energy, in the case where the toner images are formed on the front surface and the back surface of the pressure-bonded postcard, the toner of the toner images which have already been formed earlier on the superposed surfaces is hard to be melted again. If so, the toner is not transferred from one surface to the other surface of the pressure-bonded postcard during unsealing of the pressure-bonded postcard, so that an image defect is hard to generate on the toner images on the superposed surfaces of the pressure-bonded postcard.

Incidentally, in the above-described embodiment, the net basis weight of the pressure-bonded postcard is acquired using the base material layer number associated with the “kind of folding” selected in the “pressure-bonded postcard setting screen” shown in parts (a) and (b) of FIG. 8, but the present disclosure is not limited thereto. In the case of a user who does not know the “kind of folding”, the user cannot originally select the “kind of folding” in the “pressure-bonded postcard setting screen” shown in parts (a) and (b) of FIG. 8. For such a user, as shown in parts (a) and (b) of FIG. 10, the user may also be made capable of selecting “layer number of paper by folding (processing)” from the “pressure-bonded postcard setting screen”. In this case, when the “processing contents” corresponding to the “details of pressure processing” are operated by the user, a pull-down button as shown in part (b) of FIG. 10 is displayed. In the pull-down button, the base material layer numbers such as two layers, three layers, and four layers are displayed in a selectable manner by the user. The user is capable of selecting the “base material layer number” from those displayed on the pull-down button depending on a desired pressure-bonded postcard on which images are to be formed. In part (a) of FIG. 10, a state in which the “three layers” is selected as the “base material layer number” of the pressure-bonded postcard is shown. The pressure-bonded postcard which is an image forming object in this case is the pressure-bonded postcard of the outward three fold or the inward three fold.

Incidentally, in the device embodiment, in order to decrease the thermal energy imparted to the pressure-bonded postcard, the control temperature of the heater 84 is lowered, but when the thermal energy imparted to the pressure-bonded postcard can be decreased, the thermal energy decreasing means is not limited thereto. For example, in the case where the images are formed on the front surface and the back surface of the pressure-bonded postcard, the thermal energy imparted to the pressure-bonded postcard is capable of being decreased when a heating time to the recording material S in the fixing device 8 is made shorter than in the case where the images are formed on the front surface and the back surface of a normal postcard. In order to shorten the heating time to the recording material S, a length of the fixing nip N2 may be made short, or pressure of the fixing nip N2 in the fixing device 8 may be made strong, or the like. Or, in order to shorten the heating time to the recording material S, for example, the speed of the fixing motor 83 (conveying speed of the recording material S) may also be made fast. In that case, when the pressure-bonded postcards have the same net basis weight (for example, see the basis weight” 301 to 400 g/m² in the table 2), the speed of the fixing motor 83 is set to a first rotational speed (150 mm/sec) in the case where the selected base material layer number is a first layer number (two layers) and is set to a second rotational speed (200 mm/sec) faster than the first rotational speed in the case where the selected base material layer number is a second layer number (three layers) larger than the first layer number.

Further, in the above-described embodiment, the images formed on the superposed surfaces and the images formed on the front surface and the back surface of the pressure-bonded postcard were formed in the same toner application amount, but the present disclosure is not limited thereto. Ordinarily, black character images are formed on the front surface and the back surface of the pressure-bonded postcard, and therefore, black (monochromatic) toner images are formed and fixed in a maximum toner application amount (0.45 mg/cm²) on the front surface and the back surface of the pressure-bonded postcard. At that time, compared with the case where multi-color toner images are formed and fixed, the thermal energy imparted to the pressure-bonded postcard may be decreased.

### Second Embodiment

Next, a second embodiment will be described. In the case where the images are formed on the front surface and the back surface of the pressure-bonded postcard, in the conventional constitution, there was a liability that the image defect occurs on the images formed on the front surface and the back surface. This is because when the images are formed on the front surface and the back surface of the pressure-bonded postcard, although an electric resistance of the pressure-bonded postcard becomes large depending on the base material layer number, i.e., the net basis weight, a secondary transfer voltage which is the same as a secondary transfer voltage for the normal recording material S is applied and thus a sufficient secondary transfer current does not flow through the secondary transfer nip N1. Due to a low secondary transfer current, the toner images become hard to be appropriately transferred from the intermediary transfer belt 130 onto the pressure-bonded postcard, so that a desired image density was not obtained. Therefore, in this embodiment, in the case where the images are formed on the front surface and the back surface of the pressure-bonded postcard, the secondary transfer voltage at which the toner images are capable of being appropriately transferred from the intermediary transfer belt 130 onto the pressure-bonded postcard is made settable.

### <Secondary Transfer Voltage Control>

First, an outline of secondary transfer voltage control will be described using FIG. 11 while making reference to FIG. 2. FIG. 11 is a flowchart showing the secondary transfer voltage control. In FIG. 11, of control executed by the controller 101 when an image forming job is executed, processing relating to the secondary transfer voltage control is shown in a simplification manner, and many other pieces of control when the image forming job is executed will be omitted from illustration.

Further, in FIG. 11, the case where the image forming job for forming an image on a single recording material S is executed is shown as an example.

As shown in FIG. 11, the controller 101 acquires the image forming job from the operating portion 700 or the external device 900 (S11). At that time, the controller 101 acquires, in addition to the image forming job, information designated by the user and information on the recording material S on which the image is formed. The controller 101 causes the RAM 104 to store the received information on the recording material S.

The controller 101 acquires a base voltage Vb at which a predetermined target current Itarget is caused to flow through the secondary transfer nip N1 in a state in which the recording material S is not conveyed, and causes the RAM 104 to store the base voltage Vb (S12).

This base voltage Vb is a voltage determined principally depending on an electric resistance of the outer secondary transfer roller 11 changing with use. Although omitted from illustration, in the ROM 103, a current table data in which a correlation between a water content (referred to an ambient water content) in the apparatus main assembly based on environmental information (temperature and humidity) and the target current Itarget for transferring the toner image, on the intermediary transfer belt 130, onto the recording material S has already been stored in advance. This current table data is preliminarily acquired by an experiment. The controller 101 acquires the ambient water content on the basis of the temperature and the humidity detected by the temperature/humidity sensor 32, and specifies the target current Itarget corresponding to the ambient water content by making reference to the current table data (not shown).

Further, the controller 101 acquires the base voltage Vb, corresponding to the target current Itarget, on the basis of the electric resistance of the outer secondary transfer roller 11 before the toner image on the intermediary transfer belt 130 and the recording material S onto which the toner image is transferred. In this embodiment, the controller 101 carries out ATVC (Active Transfer Voltage Control) and acquires the base voltage Vb. That is, in a state in which the outer secondary transfer roller 11 and the intermediary transfer belt 130 are in contact with each other, from the secondary transfer power source 20 to the outer secondary transfer roller 11, a predetermined voltage (test voltage) or a predetermined current (test current) is supplied. Then, a current value of the current flowing through the secondary transfer nip N1 when the predetermined voltage is supplied is detected by the current detecting circuit 21 or a voltage value of the voltage of the secondary transfer power source 20 when the predetermined current is supplied is detected by the voltage detecting circuit 22. At this time, test voltages of a plurality of levels or test currents of a plurality of levels are supplied, and a voltage-control characteristic which is a relationship between the voltage and the current is acquired, and on the basis of this voltage-current characteristic, the base voltage Vb corresponding to the target current Itarget is acquired. Or, the target current Itarget is supplied as a test current, so that an output voltage value of the voltage of the secondary transfer power source at that time may also be used as the base voltage Vb.

The controller 101 acquires a recording material shared voltage Vp depending on the electric resistance of the pressure-bonded postcard on which the image is formed, and causes the RAM 104 to store the recording material shared voltage Vp (S13). In the ROM 103, a processing table data of a table 3 shown below is stored in advance. The setting table data of the table 3 is data showing the recording material shared voltage Vp depending on the ambient water content for each combination of the deemed basis weight of the pressure-bonded postcard (specifically the pressure-bonding sheet) with the base material layer number by the folding. This setting table data of the table 3 is acquired by an experiment in advance.

TABLE 3
AWC^{*1} (g/kg)

| | | | | | | |
|---|---|---|---|---|---|---|
| BW^{*2} (g/m²) | LN^{*3} | ≤0.9 | ... | 8.9 | ... | 21.5≤ |
| ... | | | | | | |
| ... | | | | | | |

$\begin{matrix}91 to 105 & 1 & & 1000 & & … & 500 & … & 200 \\ 2 & 1550 & & … & & 900 & … & 400 & \\ 3 & 2100 & & … & & 1250 & … & 600 & \\ ⋮ & ⋮ & … & & ⋮ & … & ⋮ & & \end{matrix}$
$\begin{matrix}106 to 128 & 1 & & 1150 & & … & 600 & … & 250 \\ 2 & 1850 & & … & & 1050 & … & 500 & \\ 3 & 2550 & & … & & 1550 & … & 700 & \\ ⋮ & ⋮ & … & & ⋮ & … & ⋮ & & \end{matrix}$
$\begin{matrix}129 to 150 & & 1 & & 1300 & & … & 700 & … & 300 \\ 2 & & 2150 & & … & & 1300 & … & 600 & \\ 3 & & 3050 & & … & & 1850 & … & 900 & \\ ⋮ & & ⋮ & … & & ⋮ & … & ⋮ & & \end{matrix}$
...
...
^{*1}“AWC” is the ambient water content.
^{*2}“BW” is the basis weight.
^{*3}“LN” is the layer nip (base material layer number).

The controller 101 determines the recording material shared voltage Vp by making reference to the setting table data of the table 3 on the basis of the deemed basis weight and the base material layer number of the pressure-bonded postcard and the above-described ambient water content.

Incidentally, the recording material shared voltage Vp (transfer voltage corresponding to the electric resistance of the pressure-bonded postcard) is also changed in some instances by a surface property of the recording material S in addition to the basis weight of the recording material S. For that reason, the above-described setting table data may also be set so that the recording material shared voltage Vp is changed also by the surface property of the recording material S. Incidentally, information on the surface property of the recording material S is included in the information on the recording material S acquired by the processing of the step S11.

The controller 101 acquires an initial value of a secondary transfer voltage Vtr applied from the secondary transfer power source 20 to the outer secondary transfer roller 11 during sheet (paper) passing and causes the RAM 104 to store the initial value (S14). That is, the controller 101 acquires, as the secondary transfer voltage Vtr, a voltage “Vb+Vp” which is a sum of the above-described base voltage Vb and the above-described recording material shared voltage Vp until the recording material S reaches the secondary transfer portion T2, and causes the RAM 104 to store the voltage “Vb+Vp”. Then, the controller 101 prepares for a timing when the recording material S reaches the secondary transfer portion T2. Thus, in this embodiment, the secondary transfer voltage control in which the initial value of the secondary transfer voltage Vtr is set is executed during non-image formation.

### <Image Forming Processing>

Next, the “image forming processing” in the second embodiment (this embodiment) will be described using FIG. 12 while making reference to FIGS. 2, 7, and 8. The “image forming processing” in this embodiment is started by the controller 101 (specifically, the CPU 102) for example, in the case where the image forming job is inputted from the operating portion 700 or in the case where the image forming job is received from the external device 900. Incidentally, processes which are the same as those of the “image forming processing” (see FIG. 5) in the above-described embodiment 1 will be briefly described or omitted from description by adding the same step numbers.

As shown in FIG. 5, the controller 101 specifies the recording material S which is an image forming object selected in advance by the user from the “recording material kind selecting screen” shown in FIG. 7 and stored in the RAM 104 (S1). Then, the controller 101 discriminates whether or not the specified recording material S which is the image forming object is the “pressure-bonded postcard” (S2). Whether or not the specified recording material S is the “pressure-bonded postcard” is selected in accordance with presence or absence of the operation of the “OK” button (see FIG. 7) of the “pressure-bonded postcard setting” by the user as described above.

In the case where the recording material S which is the image forming object is not the “pressure-bonded postcard” (NO of S2), the controller sets a secondary transfer condition of the secondary transfer portion 200 depending on the deemed basis weight of the normal recording material S selected by the user in the “recording material kind selecting screen” shown in FIG. 7 (S23). At this time, the controller 101 sets the secondary transfer condition for the normal recording material S by making reference to the setting table data of the above-described table 3. As an example, the ambient water content is assumed as “8.9 g/kg”. For example, in the case where “thick paper 1 (106 to 128 g/m²)” is selected from the “recording material kind selecting screen” of FIG. 7 and the “ON” button of the “pressure-bonded postcard setting” is not operated, the controller 101 regards the base material layer number as “one layer” and sets the secondary transfer voltage, applied from the secondary transfer power source 20, to “600 V” (second voltage) by making reference to the setting table data of the table 3. Then, the controller 101 starts an operation in the “normal printing mode” as the image forming mode for the normal recording material S in accordance with the set secondary transfer condition (S22).

On the other hand, in the case where the recording material S which is the image forming object is the “pressure-bonded postcard” (YES of S2), the controller 101 specifies the kind of folding (S3). The kind of folding is selected in advance by the user from the “pressure-bonded postcard setting screen” shown in parts (a) and (b) of FIG. 8, and causes the RAM 104 to store the selected kind of folding. The controller 101 sets the secondary transfer condition of the secondary transfer portion 200 depending on the deemed basis weight of the recording material S selected by the user in the “recording material kind selecting screen” shown in FIG. 7 and the kind of folding selected by the user in the “pressure-bonded postcard setting screen” shown in parts (a) and (b) of FIG. 8 (S21). At this time, the controller 101 sets the secondary transfer condition for the pressure-bonded postcard by making reference to the setting table data of the above-described table 3. Then, the controller 101 starts an operation in the “pressure-bonded postcard mode” as the image forming mode for the pressure-bonded postcard in accordance with the set fixing condition (S22).

As an example, the ambient water content is assumed as “8.9 g/kg”. For example, in the case where the “thick paper 1 (106 to 128 g/m²) is selected as the recording material S from the “recording material kind selecting screen” and the kind of folding selected in the “two fold” is “two layers” (see FIG. 3). Accordingly, the controller 101 makes reference to the setting table data of the table 3 and sets the secondary transfer voltage, applied from the secondary transfer power source, to “1050 V” (first voltage). For example, in the case where the “thick paper 1 (106 to 128 g/m²) is selected as the recording material S from the “recording material kind selecting screen” and the kind of folding selected in the “pressure-bonded postcard setting screen” is “inward three fold”, the base material layer number associated with the “inward three fold” is “three layers” (see FIG. 3). Accordingly, the controller 101 makes reference to the setting table data of the table 3 and sets the secondary transfer voltage, applied from the secondary transfer power source, to “1550 V” (first voltage).

Incidentally, in this embodiment, when the basis weights of the recording materials S before the pressure bonding when the operation in the “pressure-bonded postcard mode” is performed are substantially equal to each other, the voltage applied to the secondary transfer portion 200 in the case where the recording material layer number is a first layer number is set to a voltage higher in absolute value than in the case where the recording material layer number is a second layer number smaller than the first layer number (see the table 3). Further, when the basis weights of the recording materials S before the pressure bonding when the operation in the “pressure-bonded postcard mode” is performed are substantially equal to each other and the base material layer numbers of the pressure-bonded postcards are the same, the voltage applied to the secondary transfer portion 200 in the case where the ambient water content is a first water content is set to a voltage lower in absolute value than the voltage applied to the secondary transfer portion 200 in the case where the water content detected by the above-described detecting portion is a second water content smaller than the first water content (see the table 3).

As described above, also in the second embodiment, similarly as in the embodiment 1, in the case where the operation in the “pressure-bonded postcard mode” in which the images are formed on the front surface and the back surface of the pressure-bonded postcard is performed, the “pressure-bonded postcard setting screen” (see part (a) of FIG. 8) is displayed on the operating portion 700, so that input of the “kind of folding” is selectively prompted to the user. Then, on the basis of the “deemed basis weight” and the “base material layer number” of the pressure-bonded postcard depending on the “kind of folding” selected by the user, setting of the control voltage of the secondary transfer power source 20 for applying the secondary transfer voltage to the secondary transfer portion 200 was changed (see the table 3). In the case where the operation in the “pressure-bonded postcard mode” is performed, the control voltage of the secondary transfer power source 20 is made higher than when the operation in the “normal printing mode” is performed for the recording material S (the recording material S of the one layer) having the substantially same basis weight before being subjected to the pressure bonding processing. Thus, the voltage applied to the secondary transfer portion 200 is made high is absolute value, whereby a sufficient secondary transfer current flows through the secondary transfer nip N1 when the toner images are formed on the front surface and the back surface of the pressure-bonded postcard, so that the toner images are appropriately transferred from the intermediary transfer belt 130 onto the pressure-bonded postcard. That is, the image defect becomes hard to occur in the toner images on the front surface and the back surface of the pressure-bonded postcard.

Incidentally, in the above-described first and second embodiments, the image forming apparatus 100 of the intermediary transfer type in which the toner images are primarily transferred from the photosensitive drums 3a to 3d for the respective colors onto the intermediary transfer belt 130 and thereafter are secondarily transferred from the intermediary transfer belt 130 onto the recording material S was described as an example, but the present disclosure is not limited thereto.

The above-described first and second embodiments are also applicable to an image forming apparatus of a direct transfer type in which the toner images are directly transferred from the photosensitive drums 3a to 3d, for the respective colors, each rotating while carrying the toner image onto the recording material S.

According to the present disclosure, in the case where the toner image is formed on an outer surface of the pressure-bonded recording material which has already been folded and pressure-bonded, it is possible to make the image defect hard to occur in the toner images on the superposed inner surfaces or in the toner image on the outer surface of the pressure-bonded recording material.

### Other Embodiments

The above-described embodiments of the present disclosure can also be realized by a computer of a system or apparatus that reads out and executes computer executable instructions (e.g., one or more programs) recorded on a storage medium (which may also be referred to more fully as a “non-transitory computer-readable storage medium”) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disk (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-151935, filed on Sep. 4, 2024, which is hereby incorporated by reference herein in its entirety.

What is claimed is:

1. An image forming apparatus comprising:
an image forming portion configured to form a toner image on a recording material;
a fixing portion configured to fix the toner image, on the recording material, formed on the recording material by the image forming portion;
an input portion configured to input information on the recording material; and
a controller,
wherein in a case where the controller executes an operation in a first mode in which the toner image is formed on a pressure-bonded recording material bent and pressure-bonded so that one surface of the recording material becomes an opposing inner surface, the controller controls the fixing portion on the basis of first information on a basis weight of the pressure-bonded recording material and second information on a folding shape of the pressure-bonded recording material, which are inputted by the input portion.

2. The image forming apparatus according to claim 1, wherein the fixing portion includes a first rotatable member, a second rotatable member for forming a fixing nip in which the recording material is nipped and conveyed in contact with the first rotatable member, and a heating portion for heating the first rotatable member,
wherein the input portion is provided with a display portion capable of displaying the information and capable of being operated by a user,
wherein the controller causes the display portion to display a selection screen on which the user is capable of selecting a recording material layer number in a superposed portion of the pressure-bonded recording material when the controller executes the operation in the first mode, and
wherein the controller sets a temperature of the heating portion in a case where the recording material layer number selected by the user is a first layer number so as to be lower than a temperature in a case where the recording material layer number selected by the user is a second layer number larger than the first layer number.

3. The image forming apparatus according to claim 2, further comprising a rotation driving portion configured to rotationally drive the first rotatable member,
wherein the controller makes a speed of the rotation driving portion when the controller executes the operation in the first mode faster than a speed of the rotation driving portion when the controller executes an operation in a second mode.

4. The image forming apparatus according to claim 3, wherein the controller causes the display portion to display the selection screen on which the user is capable of selecting the recording material layer number in the superposed portion of the pressure-bonded recording material when the controller executes the operation in the first mode, and
wherein the controller sets the speed of the rotation driving portion to a first rotational speed in the case where the recording material layer number selected by the user is the first layer number, and sets the speed of the rotation driving portion to a second rotational speed faster than the first rotational speed in the case where the recording material layer number selected by the user is the second layer number larger than the first layer number.

5. An image forming apparatus comprising:
an image forming portion configured to form a toner image on a recording material;
a fixing portion configured to fix the toner image, on the recording material, formed on the recording material by the image forming portion;
an input portion configured to input information on the recording material; and
a controller,
wherein the image forming apparatus is capable of executing an operation in a first mode in which the toner image is formed on a pressure-bonded recording material bent and pressure-bonded so that one surface of the recording material becomes an opposing inner surface, and an operation in a second mode in which the toner image is formed on a recording material which is not pressure-bonded,
wherein the controller sets a fixing temperature of the fixing portion to a first temperature in a case where the toner image is formed on a recording material with a first basis weight in the operation in the first mode, and sets the fixing temperature of the fixing portion to a second temperature in a case where the toner image is formed on the recording material with the first basis weight in the operation in the second mode, and
wherein the first temperature is lower than the second temperature.

6. The image forming apparatus according to claim 5, wherein the fixing portion includes a first rotatable member, a second rotatable member for forming a fixing nip in which the recording material is nipped and conveyed in contact with the first rotatable member, and a heating portion for heating the first rotatable member, and
the controller controls the heating portion and sets the fixing temperature of the fixing portion to the first temperature in the operation in the first mode and to the second temperature in the operation in the second mode.

7. The image forming apparatus according to claim 6, wherein the input portion is provided with a display portion capable of displaying the information and capable of being operated by a user,
wherein the controller causes the display portion to display a selection screen on which the user is capable of selecting a recording material layer number in a superposed portion of the pressure-bonded recording material when the controller executes the operation in the first mode, and
wherein when the controller executes the operation in the first mode, the controller sets a temperature of the heating portion in a case where the recording material layer number selected by the user is a first layer number so as to be lower than a temperature in a case where the recording material layer number selected by the user is a second layer number larger than the first layer number.

8. The image forming apparatus according to claim 6, further comprising a rotation driving portion configured to rotationally drive the first rotatable member,
wherein the controller makes a speed of the rotation driving portion when the controller executes the operation in the first mode faster than a speed of the rotation driving portion when the controller executes an operation in a second mode.

9. The image forming apparatus according to claim 8, wherein the input portion is provided with a display portion capable of displaying the information and capable of being operated by a user,
wherein the controller causes the display portion to display a selection screen on which the user is capable of selecting a recording material layer number in a superposed portion of the pressure-bonded recording material when the controller executes the operation in the first mode, and
wherein when the controller executes the operation in the first mode, the controller sets the speed of the rotation driving portion to a first rotational speed in the case where the recording material layer number selected by the user is a first layer number, and sets the speed of the rotation driving portion to a second rotational speed faster than the first rotational speed in the case where the recording material layer number selected by the user is a second layer number larger than the first layer number.

10. An image forming apparatus comprising:
an image bearing member configured to bear a toner image;
an image forming unit configured to form the toner image on the image bearing member;
a transfer portion configured to transfer the toner image, onto a recording material, formed by the image forming user and borne by the image bearing member;
a power source configured to apply a voltage to the transfer portion;
an input portion configured to input information on the recording material; and
a controller,
wherein in a case where the controller executes an operation in a first mode in which the toner image is formed on a pressure-bonded recording material bent and pressure-bonded so that one surface of the recording material becomes an opposing inner surface, the controller controls the power source on the basis of first information on a basis weight of the pressure-bonded recording material and second information on a folding shape of the pressure-bonded recording material, which are inputted by the input portion.

11. The image forming apparatus according to claim 10, wherein the input portion is provided with a display portion capable of displaying the information and capable of being operated by a user,
wherein the controller causes the display portion to display a selection screen on which the user is capable of selecting a recording material layer number in a superposed portion of the pressure-bonded recording material when the controller executes the operation in the first mode, and
wherein the controller sets the voltage of the transfer portion in a case where the recording material layer number selected by the user is a first layer number so as to be higher in absolute value than a voltage in a case where the recording material layer number selected by the user is a second layer number smaller than the first layer number.

12. The image forming apparatus according to claim 11, further comprising a detecting portion configured to detect a water content in a main assembly of the image forming apparatus,
wherein when the controller executes the operation in the first mode, the controller sets a voltage of the transfer portion in a case where the water content detected by the detecting portion is a first water content so as to be lower in absolute value than a voltage of the transfer portion in a case where the water content detected by the detecting portion is a second water content smaller than the first water content.

13. The image forming apparatus according to claim 12, wherein the detecting portion is a temperature/humidity sensor for detecting a temperature and a humidity.

14. An image forming apparatus comprising:
an image bearing member configured to bear a toner image;
an image forming unit configured to form the toner image on the image bearing member;
a transfer portion configured to transfer the toner image, onto a recording material, formed by the image forming unit and borne by the image bearing member;
a power source configured to apply a voltage to the transfer portion;
an input portion configured to input information on the recording material; and
a controller,
wherein the image forming apparatus is capable of executing an operation in a first mode in which the toner image is formed on a pressure-bonded recording material bent and pressure-bonded so that one surface of the recording material becomes an opposing inner surface, and an operation in a second mode in which the toner image is formed on a recording material which is not pressure-bonded,
wherein the controller sets the voltage of the transfer portion to a first voltage in a case where the toner image is formed on a recording material with a first basis weight in the operation in the first mode, and sets a fixing temperature of a fixing portion to a second voltage in a case where the toner image is formed on the recording material with the first basis weight in the operation in the second mode, and
wherein the first voltage is higher in absolute value than the second voltage.

15. The image forming apparatus according to claim 14, wherein the input portion is provided with a display portion capable of displaying the information and capable of being operated by a user,
wherein the controller causes the display portion to display a selection screen on which the user is capable of selecting a recording material layer number in a superposed portion of the pressure-bonded recording material when the controller executes the operation in the first mode, and
wherein when the controller executes the operation in the first mode, the controller sets the voltage of the transfer portion in the case where the recording material layer number selected by the user is a first layer number so as to be higher in absolute value than a voltage in the case where the recording material layer number selected by the user is a second layer number smaller than the first layer number.

16. The image forming apparatus according to claim 15, further comprising a detecting portion configured to detect a water content in a main assembly of the image forming apparatus,
wherein when the controller executes the operation in the first mode, the controller sets a voltage of the transfer portion in a case where the water content detected by the detecting portion is a first water content so as to be lower in absolute value than a voltage of the transfer portion in a case where the water content detected by the detecting portion is a second water content smaller than the first water content.

17. The image forming apparatus according to claim 16, wherein the detecting portion is a temperature/humidity sensor for detecting a temperature and a humidity.
